(19) United States
(12) Patent Application Publication
(10) Pub. No.: US 2020/0284320 A1
(43) Pub. Date: Sep. 10, 2020

(54) WEAR COMPENSATION FOR SHAFTS SUPPORTED ON FRICTION BEARINGS

(71) Applicants: ZF Friedrichshafen AG, Friedrichshafen (DE); ZF Wind Power Antwerpen N.V., Lommel (BE)

(72) Inventor: Dirk Leimann, Edegem (BE)

(21) Appl. No.: 16/464,278

(22) PCT Filed: Nov. 6, 2017
(86) PCT No.: PCT/EP2017/078274

§ 371 Date: May 27, 2019

(30) Foreign Application Priority Data
Nov. 30, 2016 (DE) 10 2016 223 833.7

(51) Int. Cl. F16H 1/06; F16H 55/17; F16H 57/00

(52) U.S. Cl. CPC F16H 1/06; F16H 57/00; F16H 55/17

(57) ABSTRACT

An arrangement includes a friction-bearing supported first gear with a pitch diameter d₁ and a friction-bearing supported second gear with a pitch diameter d₂. The first gear and the second gear intermesh with each other, and a distance a between an axis of rotation of the first gear and an axis of rotation of the second gear increase during operation by up to Δₐ^{wear}. A nominal dimension Nₐ is provided for the distance a, wherein Nₐ=(d₁+d₂−Δₐ^{wear})/2.

### CROSS REFERENCE TO RELATED APPLICATIONS

This application is a U.S. National Stage Application under 35 U.S.C. § 371 of International Application No. PCT/EP2017/078274 filed on Nov. 6, 2017, and claims benefit to German Patent Application No. DE 10 2016 223 833.7 filed on Nov. 30, 2016. The International Application was published in German on Jun. 7, 2018 as WO 2018/099687 A2 under PCT Article 21(2).

### FIELD

The invention relates to an arrangement comprising a friction-bearing supported first gear (101) with a pitch diameter d₁ and a friction-bearing supported second gear (103) with a pitch diameter d₂ and to a method for improving the wear resistance of such an arrangement.

### BACKGROUND

If a first gear with a pitch diameter d₁ and a second gear with a pitch diameter d₂ intermesh with each other, a nominal dimension for the distance of an axis of rotation of the first gear from an axis of rotation of the second gear will, according to solutions as known from the prior art, amount to

Nₐ=(d₁+d₂)/2.

Friction bearings are being increasingly used in wind turbine gearboxes. They have positive effects in terms of noise and vibration characteristics. Wind turbines, however, are subject to operating conditions that involve an increased wear of the friction bearings. Among these conditions are frequent starts and stops as well as idle operation.

An axial offset in the gearings of gears intermeshing with each other is a result of the wear. Such offset is only tolerable within certain limits. Any additional wear will lead to damages.

### SUMMARY

In an embodiment, the present invention provides an arrangement. The arrangement includes a friction-bearing supported first gear with a pitch diameter d₁ and a friction-bearing supported second gear with a pitch diameter d₂. The first gear and the second gear intermesh with each other and a distance a between an axis of rotation of the first gear and an axis of rotation of the second gear increase during operation by up to Δₐ^{wear}. A nominal dimension Nₐ is provided for the distance a, wherein Nₐ=(d₁+d₂−Δₐ^{wear})/2.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows two gears intermeshing with each other; and

FIG. 2 shows a bearing of the gears.

### DETAILED DESCRIPTION

Embodiments of the invention avoid certain drawbacks inherent in solutions known from the prior art. Embodiments of the invention increase the lifetime of an arrangement with friction-bearing supported gears under adverse operating conditions.

An arrangement according to embodiments of the invention comprises a friction-bearing supported, preferably exclusively friction-bearing supported, first gear and a friction-bearing supported, preferably exclusively friction-bearing supported, second gear. The first gear and the second gear intermesh with each other. An axis of rotation of the first gear and an axis of rotation of the second gear run preferably parallel to each other. The two axes of rotation are—apart from changes as a result of wear and/or bearing clearance

The first gear is preferably fixed on a first shaft, the second gear on a second shaft. In this case, the gears are friction-bearing supported via the shafts. In particular, the first shaft and the second shaft are friction-bearing supported, preferably exclusively.

The fixation of the two gears on the shafts is carried out at least in a non-rotatable manner such that an at least non-rotatable connection exists in each case between the first shaft and the first gear as well as between the second shaft and the second gear. Preferably, the first shaft and the first gear as well as the second shaft and the second gear are in each case fixed immovably in relation to each other, that is to say, without a relative degree of freedom of movement.

During operation, that is to say, from starting up to closing down the arrangement, wear occurs in friction bearings, by which the first gear or, as the case may be, the first shaft, and the second gear or, as the case may be, the second shaft, are supported. In the process, a distance a between an axis of rotation of the first gear or, as the case may be, of the first shaft, and an axis of rotation of the second gear or, as the case may be, of the second shaft, increases by up to Δₐ^{wear}. Preferably, Δₐ^{wear} not only comprises a wear-related increase of the distance a, but also an increase of the distance a as a result of bearing clearance of the two shafts.

The distance a is defined as length of the shortest distance of all distances connecting the two axes of rotation.

If the distance a between the axis of rotation of the first gear or, as the case may be, of the first shaft, and the axis of rotation of the second gear or, as the case may be, of the second shaft, at the time of starting up is a_{Beginn} and at the time of closing down is a_{Ende}, the following applies:

a_{Beginn}≤a_{Ende}≤a_{Beginn}+Δₐ^{wear}.

According to embodiments of the invention, the following applies:

Nₐ=(d₁+d₂−Δₐ^{wear})/2.

In this context, Nₐ refers to a nominal dimension for the distance a between the axis of rotation of the first gear or, as the case may be, of the first shaft, and the axis of rotation of the second gear or, as the case may be, of the second shaft, at the time of starting up. d₁ refers to a pitch diameter of the first gear, d₂ correspondingly to a pitch diameter of the second gear.

A nominal dimension is defined in Hoischen, Hesser: “Technisches Zeichnen”, 33rd edition, Comelson Verlag, 2013, page 163. Nominal dimension accordingly is a reference value used to determine an upper and a lower limit.

A pitch diameter is defined in Steinhilper, Sauer “Konstruktionselemente des Maschinenbaus 2—Grundlagen von Maschinenelementen für Antriebsaufgaben”, 5th edition, Springer-Verlag, 2012, page 398.

The invention takes into account the capability of the gearing of the first gear and of the second gear to tolerate an axial offset of the first shaft and of the second shaft without damages. The nominal dimension Nₐ is selected such that a negative axial offset is present at the time of starting up. The axial offset increases with wear. The absolute value of the axial offset, however, initially decreases. In this manner, the capability of the gearings of the first gear and of the second gear to tolerate an axial offset is optimally utilized.

Caused by production, deviations of the distance a between the axis of rotation of the first gear or, as the case may be, of the first shaft, and the axis of rotation of the second gear or, as the case may be, of the second shaft, from the nominal dimension Nₐ can occur. Tₐ⁻ refers to a production-related maximum downward deviation of the distance a between the first shaft and the second shaft from the nominal dimension Nₐ. Thus, the following applies

Nₐ−Tₐ⁻≤a.

aₘᵢₙ refers to a minimum value for the distance a between the first shaft and the second shaft that is tolerated by the gearings of the first gear and of the second gear. In order for the gearings of the first gear and of the second gear to intermesh without damages, aₘᵢₙ≤a must therefore apply.

Against this background, the arrangement is configured according to further developments such that the following applies:

aₘᵢₙ≤Nₐ−Tₐ⁻

In order to determine Tₐ⁻ or Δₐ^{wear}, this equation can optionally be equivalently transformed as follows:

Tₐ⁻≤(d₁+d₂−Δₐ^{wear})/2−aₘᵢₙ

or, as the case may be,

Δₐ^{wear}≤d₁+d₂−2*(aₘᵢₙ+Tₐ⁻).

Let Tₐ⁺ refer to a maximum upward deviation of the distance a between the axis of rotation of the first gear or, as the case may be, of the first shaft, and the axis of rotation of the second gear or, as the case may be, of the second shaft, from the nominal dimension Nₐ. Thus, the following applies

a≤Nₐ+Tₐ⁺.

Let a maximum value of the distance a between the axis of rotation of the first gear or, as the case may be, of the first shaft, and the axis of rotation of the second gear or, as the case may be, of the second shaft, that is tolerated by the gearings of the first gear and of the second gear be referred to as aₘₐₓ. In order for the gearings of the first gear and of the second gear to intermesh without damages, a≤aₘₐₓ must therefore apply.

The arrangement is preferentially developed further in such a manner that the following applies:

Nₐ−Tₐ⁺+Δₐ^{wear}/2≤aₘₐₓ

In order to determine Tₐ⁺ or Δₐ^{wear}, this equation can be optionally equivalently transformed as follows:

Nₐ≤aₘₐₓ−Tₐ⁺−Δₐ^{wear}/2

or, as the case may be,

Δₐ^{wear}≤2*(aₘₐₓ−Tₐ⁺−Nₐ).

In the context of the present invention, involute-toothed gears are particularly advantageous because they tolerate a high axial offset. High deviations of the distance a between the axis of rotation of the first gear or, as the case may be, of the first shaft, and the axis of rotation of the second gear or, as the case may be, of the second shaft, from the nominal dimension Nₐ can thus be realized by means of an involute-toothed first and second gear.

A method according to the invention provides to select the nominal dimension Nₐ for the distance between the axis of rotation of the first gear or, as the case may be, of the first shaft, and the axis of rotation of the second gear or, as the case may be, of the second shaft, such that the following applies:

Nₐ=(d₁+d₂)/2.

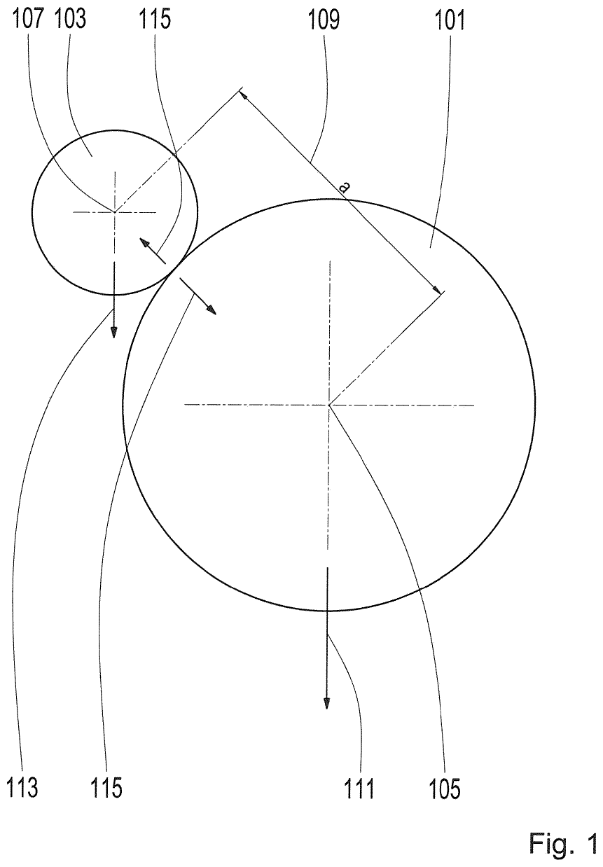

A first gear 101 and a second gear 103 intermesh with each other as illustrated in FIG. 1. The first gear 101 is supported rotatably about a first axis of rotation 105. The second gear 103 is supported rotatably about a second axis of rotation 107.

The first axis of rotation 105 and the second axis of rotation 107 run at a distance 109 from one another. In particular, both axes of rotation 105, 107 are aligned parallel to each other.

Caused by the deadweight of the first gear 101, a first normal force 111 acts in the first axis of rotation 105. Correspondingly, a second normal force 113 acts in the second axis of rotation 107 caused by the deadweight of the second gear 103.

In addition, gearing forces 113 resulting from the meshing of a gearing of the first gear 101 and of a gearing of the second gear 103 act along a connecting line between the first axis of rotation 105 and the second axis of rotation 109.

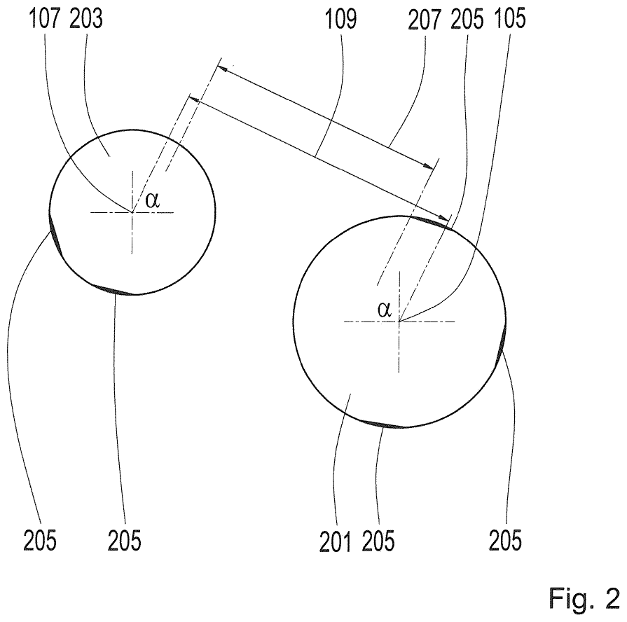

The first normal force 111 and the second normal force 113 and the gearing forces 115 load the bearing of the first gear 101 and of the second gear 103 and there lead to wear. This is illustrated in FIG. 2.

FIG. 2 shows a first friction bearing 201, by which the first gear 101 is rotatably supported, and a second friction bearing 203, by which the second gear 103 is rotatably supported. The first normal force 111, the second normal force 113, and the gearing forces lead to material abrasion 205 in the first bearing 201 and in the second bearing 203 due to wear.

The material abrasion 205 involves an increased distance 109 between the first axis of rotation 105 and the second axis of rotation 107. In order to compensate for this, the illustrated exemplary embodiment is put into operation with a reduced distance 207 between the first axis of rotation 105 and the second axis of rotation 107.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE CHARACTERS

101 First gear
103 Second gear
105 First axis of rotation
107 Second axis of rotation
109 Distance
111 First normal force
113 Second normal force
115 Gearing forces
201 First bearing
203 Second bearing
205 Material abrasion
207 Reduced distance

1. An arrangement, comprising:
a friction-bearing supported first gear with a pitch diameter d₁; and
a friction-bearing supported second gear with a pitch diameter d₂;
wherein the first gear and the second gear intermesh with each other;
wherein a distance a between an axis of rotation of the first gear and an axis of rotation of the second gear increase during operation by up to Δₐ^{wear}; and
wherein a nominal dimension Nₐ is provided for the distance a, wherein Nₐ=(d₁+d₂−Δₐ^{wear})/2.

2. The arrangement according to claim 1, wherein the distance a can deviate downward from the nominal dimension Tₐ⁻ by up to Nₐ caused by production;
wherein gearings of the first gear and of the second gear tolerate a distance a that is reduced by up to aₘᵢₙ;
wherein aₘᵢₙ≤Nₐ−Tₐ⁺.

3. The arrangement according to claim 1, wherein the distance a can deviate upward from the nominal dimension Nₐ by up to Tₐ⁺ caused by production;
wherein the gearings of the first gear and of the second gear tolerate a distance a that is increased by up to aₘₐₓ;
wherein Nₐ+Tₐ⁺+Δₐ^{wear}/2≤aₘₐₓ

4. The arrangement according to claim 3, wherein the first gear and the second gear are involute-toothed.

5. A method to improve the wear resistance of an arrangement according to claim 1; the method comprising selecting the nominal dimension Nₐ for the distance a such that the following applies: Nₐ=(d₁+d₂−Δₐ^{wear})/2.
